(19) United States
(12) Patent Application Publication
(10) Pub. No.: US 2021/0094224 A1
(43) Pub. Date: Apr. 1, 2021

(54) RESIN CASSETTES WITH INTERNAL GEOMETRY SHAPED TO MINIMIZE GHOSTING DURING ADDITIVE MANUFACTURING

(71) Applicant: Carbon, Inc., Redwood City, CA (US)

(72) Inventors: Rene Lopez, Redwood City, CA (US); Bernard Carreon, Berkeley, CA (US); Jean-Claude de Sugny, San Francisco, CA (US)

(21) Appl. No.: 17/032,398

(22) Filed: Sep. 25, 2020

Related U.S. Application Data
(60) Provisional application No. 62/907,074, filed on Sep. 27, 2019.

(51) Int. Cl. B29C 64/124; B29C 64/245; B29C 64/255; B29C 64/232; B29C 64/393

(52) U.S. Cl. CPC B29C 64/124; B29C 64/245; B33Y 10/00; B29C 64/232; B29C 64/393; B29C 64/255

(57) ABSTRACT

A resin cassette for an additive manufacturing apparatus is provided. The apparatus has a light engine and a cassette mount operatively associated therewith, with the light engine configured to project an enlarged projected image through the resin cassette when positioned on the cassette mount. The resin cassette includes a light transmissive window configured to pass the enlarged image therethrough. The window has internal structures defining fluid flow passages therein, with the internal structures distributed across the length and width of said window. These internal structure create reflective and/or refractive surfaces within the window. The window includes a circumferential frame connected to and surrounding said window, said window and frame together forming a well configured to receive a light polymerizable resin. The shape of the internal structures is progressively varied (e.g., in a plurality of step-wise increments, and/or in a continuous or “smoothed” fashion) across the length and width of the window to reduce reflections and/or refractions within said window when said enlarged image is projected therethrough.

### RELATED APPLICATIONS

This application claims priority to U.S. Provisional Application Ser. No. 62/907,074, filed Sep. 27, 2019, the disclosure of which is incorporated by reference herein in its entirety.

### FIELD OF THE INVENTION

The present invention concerns apparatus for producing objects by additive manufacturing.

### BACKGROUND

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and U.S. Pat. No. 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

In many manufacturing environments employing advanced stereolithography techniques, there is a delicate balance between part production accuracy, part production speed, chemical reaction requirements, and chemical reaction consequences, during the production step. Optimizing one parameter, such as accuracy, may be deleterious to another parameter such as production speed. Accordingly, there remains a need for improvements in advanced stereolithography processes and apparatus.

### SUMMARY

We have found that, in bottom-up stereolithography apparatus that feed a polymerization inhibitor such as oxygen through the light transmissive window, the inhibitor supply bed in the window can cause reflections, refractions, or both reflections and refractions, of the light image as it passes through the window, leading to a decrease in part accuracy. This phenomenon may be referred to as reflective or refractive ghosting, or simply “ghosting.” By modifying the internal structure of the inhibitor supply bed as described herein, ghosting arising from reflection and/or refraction of light in the window can be reduced.

Accordingly, described herein is a resin cassette for an additive manufacturing apparatus. The apparatus has a light engine and a cassette mount operatively associated therewith, with the light engine configured to project an enlarged projected image through the resin cassette when positioned on the cassette mount. The resin cassette includes a light transmissive window configured to pass the enlarged image therethrough. The window has internal structures defining fluid flow passages therein (e.g., for carrying a coolant, or more preferably for carrying a polymerization inhibitor), with the internal structures distributed across the length and width of said window. These internal structure create reflective and/or refractive surfaces within the window. The window includes a circumferential frame connected to and surrounding said window, said window and frame together forming a well configured to receive a light polymerizable resin. The shape of the internal structures is progressively varied (e.g., in a plurality of step-wise increments, and/or in a continuous or “smoothed” fashion) across the length and width of the window to reduce reflections and/or refractions within said window when said enlarged image is projected therethrough.

In some embodiments, a resin cassette for an additive manufacturing apparatus is provided. The apparatus has a light engine and a cassette mount operatively associated therewith, the light engine configured for projecting an enlarged projected image through the resin cassette when positioned on said cassette mount. The resin cassette includes (a) a light transmissive window configured to pass the enlarged image therethrough, the window having internal structures defining fluid flow passages therein, with the internal structures distributed across the length and width of said window, and with the internal structures creating reflective and refractive surfaces within the window; and (b) a circumferential frame connected to and surrounding said window, the window and frame together forming a well configured to receive a light polymerizable resin. The shape of the internal structures is progressively varied (e.g., in a plurality of step-wise increments, and/or in a continuous or “smoothed” fashion) across the length and width of said window to reduce reflections and/or refractions within said window when said enlarged image is projected therethrough.

In some embodiments, the internal structures comprise walls and the passages comprise laterally aligned (e.g., parallel) channels.

In some embodiments, the internal structures comprise pillars and said passages comprise intersecting channels.

In some embodiments, the channels are triangular and/or quadrangular in profile.

In some embodiments, the window comprises a sandwich of at least top portion an intermediate portion, and a bottom portion, and the internal structures are formed in the intermediate portion.

In some embodiments, the window bottom portion comprises glass, sapphire, quartz, or transparent aluminum (ALON).

In some embodiments, the top portion comprises a polymer (e.g., an oxygen-permeable polymer such as an amorphous fluoropolymer), optionally with a fluorophore dispersed therein.

In some embodiments, the intermediate layer comprises a second polymer layer, such as a polydimethylsiloxane (PDMS) layer.

In some embodiments, a bottom-up additive manufacturing apparatus includes (a) a frame; (b) a resin cassette described herein operatively associated with said frame; (c) a light source positioned below said resin cassette and positioned for projecting an enlarged image through said window; (d) a removable carrier platform or a carrier platform engagement assembly positioned above said window and operatively associated with said frame; and (e) a drive operatively associated with said carrier and said frame and configured for advancing said carrier platform and said resin cassette away from one another.

In some embodiments, a light source comprises a micromirror array or liquid crystal display (LCD) panel.

In some embodiments, the apparatus further includes an inhibitor supply (e.g., an oxygen concentrator) operatively associated with said resin cassette fluid flow passages.

In some embodiments, the apparatus further includes a controller operatively associated with said light source and said drive.

In some embodiments, a method of making an object from a light polymerizable resin and a data file (e.g., a CAD file, an .stl file, etc.) includes (a) filling a resin cassette in an apparatus as described herein with said resin; and (b) producing said object from said data file and said resin by intermittently and/or continuously exposing said resin to an enlarged image (e.g., that is spatially and temporally modulated) from said light source to photopolymerize said resin, while advancing said carrier platform and said resin cassette away from one another.

In some embodiments, the resin comprises a dual cure resin.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a schematic illustration of one embodiment of an apparatus as described herein, showing as dashed lines the divergent chief rays of an image projected from the light source.

FIG. 2 is a top plan view of the resin cassette in FIG. 1, showing (as nested elliptical dashed lines) the increasingly divergent chief rays of an image projected from the light source.

FIG. 3 is a more detailed schematic view of one embodiment of a resin cassette for use as described herein.

FIG. 4 shows light refracted and reflected by a channel (c) having a quadrangular (specifically, a rectangular) profile in a typical resin cassette, leading to substantial “ghosting” of the image when projected into the resin.

FIG. 5A shows light refracted by a channel (c), but the channel profile has been altered to reduce refraction and/or reflection, and associated ghosting, as compared to the channel of FIG. 4.

FIG. 5B shows light refracted by a channel (c), but the channel profile has been altered to still further reduce refraction and/or reflection, and associated ghosting, as compared to the channel of FIG. 5A,

FIG. 6 schematically illustrates one channel in a resin cassette window, the channel having different cross-sectional profile configurations at points A-A, B-B, C-C, and D-D, progressively located therethrough

FIGS. 7A-7D together illustrate a preferred channel profiles at different points for the same channel, as described herein. The dashed rectangle in each Figure represents the channel profile of a prior art window for comparison.

FIG. 7A schematically illustrates a preferred channel profile for the channel of FIG. 6 at cross-section A-A.

FIG. 7B schematically illustrates a preferred channel profile for the channel of FIG. 6 at cross-section B-B.

FIG. 7C schematically illustrates a preferred channel profile for the channel of FIG. 6 at cross-section C-C.

FIG. 7D schematically illustrates a preferred channel profile for the channel of FIG. 6 at cross-section D-D.

FIGS. 8A-8D together illustrate another preferred channel profiles at different points for the same channel, as described herein. The dashed rectangle in each Figure represents the channel profile of a prior art window for comparison.

FIG. 8A schematically illustrates another preferred channel profile for the channel of FIG. 6 at cross-section A-A.

FIG. 8B schematically illustrates another preferred channel profile for the channel of FIG. 6 at cross-section B-B.

FIG. 8C schematically illustrates another preferred channel profile for the channel of FIG. 6 at cross-section C-C.

FIG. 8D schematically illustrates another preferred channel profile for the channel of FIG. 6 at cross-section D-D.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

1. Resin and Additive Manufacturing Apparatus.

Resins for additive manufacturing are known and described in, for example, U.S. Pat. Nos. 9,211,678; 9,205,601; and U.S. Pat. No. 9,216,546 to DeSimone et al. In addition, dual cure resins useful for carrying out some embodiments of the present invention are known and described in U.S. Pat. Nos. 9,676,963, 9,453,142 and 9,598,606 to Rolland et al., and in U.S. Pat. No. 10,316,213 to Arndt et al. Particular examples of suitable dual cure resins include, but are not limited to, Carbon Inc. medical polyurethane, elastomeric polyurethane, rigid polyurethane, flexible polyurethane, cyanate ester, epoxy, and silicone dual cure resins, all available from Carbon, Inc., 1089 Mills Way, Redwood City, Calif. 94063 USA.

Apparatus for carrying out bottom-up stereolithography, which can be adapted or improved as described herein, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the additive manufacturing step is carried out by one of the family of methods sometimes referred to as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, S Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); and K. Willis and B. Adzima, US Pat App Pub. No. US 2018/0290374 (Oct. 11, 2018).

2. Image Projection and Ghosting

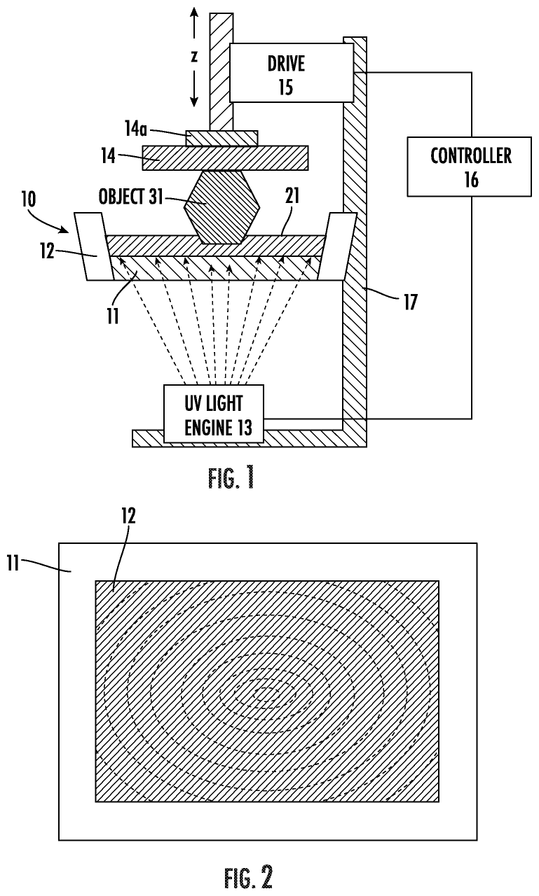

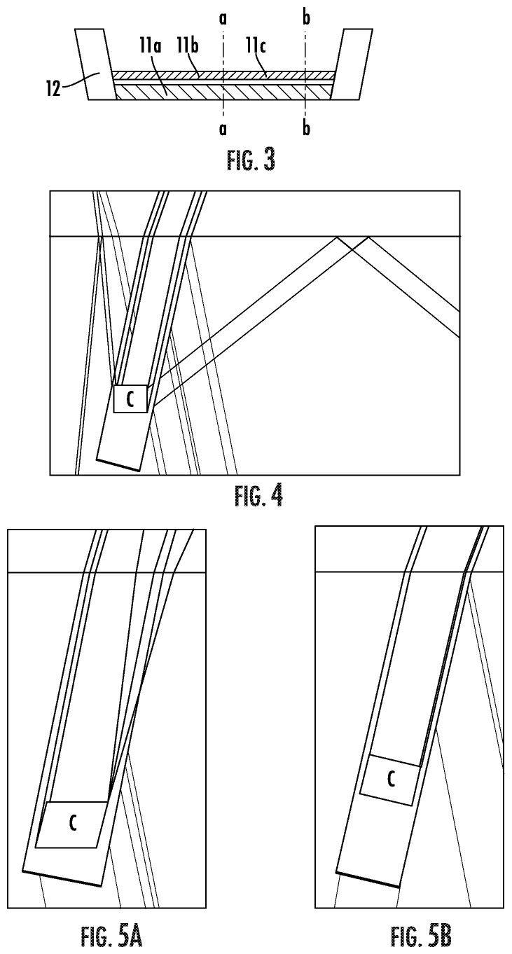

As can be seen from FIGS. 1-3, when an enlarged image is projected from a light source (such as an image projected off of a micromirror array or an image formed by projection through a liquid crystal display), the principal rays of the image diverge from substantially perpendicular at the point where they encounter the window (e.g., at point a-a in FIG. 3) to an increasingly greater angle of incidence (e.g., at point b-b in FIG. 3). We find that, when the window includes internal features such as rectangular channels, the principal rays of the image can (depending on the channel shape and the location of that channel segment) refract, reflect, or both refract and reflect, off of the channel in a progressively increasing fashion along the channel as the rays increasingly diverge from the perpendicular point (e.g., as shown in FIG. 4). This can cause reflective and/or refractive “ghosting” of the image in these portions of the window, leading to problems such as decrease in accuracy, and/or a decrease in delivery of the intended light dose to the resin, for objects produced in these portions of the regions.

3. Resin Cassettes and Apparatus.

Embodiments of apparatus and resin cassettes are shown in FIGS. 1-3. The apparatus typically includes a frame or chassis (17), a resin cassette (10) having a window (11) as described further below operatively associated with the frame (typically by means of a cassette mount, not shown); a light source (e.g., 13) positioned below the resin cassette and positioned for projecting an enlarged image through the window (11); a removable carrier platform (14), or a carrier platform engagement assembly (14a) on which the carrier platform can be mounted, positioned above the window (11) and operatively associated with the frame; and drive (15) operatively associated with said carrier and said frame and configured for advancing said carrier platform (14) and said resin cassette (10) away from one another (typically in the “Z” or vertical direction, and typically by moving the platform upward and away from an otherwise stationary window).

Any suitable light source can be used, such as one employing an ultraviolet light, projecting off of a micromirror array or through a liquid crystal display (LCD) panel.

The apparatus preferably includes a source or supply of inhibitor (not shown), such as an oxygen concentrator, that is connected to the resin cassette, and specifically to the flow passages in the resin cassette, (preferably by quick connectors) to a removable cassette, such as described in Feller and Griffin, PCT Patent Application Pub. No. WO 2019/084112, and in Feller et al., PCT Patent Application Pub. No. WO 2018/006018.

The apparatus may include a controller (16), such as a general purpose computer, located on board the apparatus, on the cloud, or a combination thereof, operatively associated with the light source and drive, and including programming for carrying out additive manufacturing on the apparatus as is known in the art.

The apparatus can optionally include heaters and/or coolers operatively associated with the window (11) and the controller (16). Any suitable devices can be used, including resistive heaters, Peltier coolers, infrared heaters, etc., including combinations thereof. The heaters/coolers are preferably directly included in the resin cassette (10), preferably in direct contact with the window (11) itself, or in the case of infrared heaters can be positioned to project into the resin (21) through the window (11).

The cassette (10), as noted above, generally includes a light transmissive window (11) configured to pass the enlarged image therethrough, the window (11) having internal structures defining fluid flow passages therein, with the internal structures distributed across the length and width of the window (11), and with the internal structures creating reflective and refractive surfaces within the window (11); and a circumferential frame (12) connected to and surrounding the window, the window (11) and frame (12) together forming a well configured to receive a light polymerizable resin (e.g., 21). A variety of geometries for these internal structures can be employed: in some embodiments, internal structures comprise walls and the passages comprise laterally aligned (e.g., parallel) channels; in some embodiments the internal structures comprise pillars (of any shape, width, and length) and the passages may comprise regularly or irregularly intersecting channels. The channels themselves may be of any suitable profile, such triangular and/or quadrangular (e.g., square, rectangular, parallelogram, etc.) in profile. The fluid flow passages may be connected to a polymerization inhibitor supply and/or a coolant supply to carry the polymerization inhibitor or coolant therein.

The cassette window can be constructed in any suitable manner, though preferably provides or includes an oxygen permeable top portion through which oxygen in fluid flow passages can pass through to resin on top of the window. In some embodiments, the window comprises a sandwich of at least top portion (11a) an intermediate portion (11b), and a bottom portion (11c), with the internal structures formed in the intermediate portion.

In some embodiments, the window bottom portion, comprises glass, sapphire, quartz, or transparent aluminum (ALON).

In some embodiments, the window top portion comprises a polymer (e.g., an oxygen-permeable polymer such as an amorphous fluoropolymer), optionally with said fluorophore dispersed therein.

In some embodiments, the intermediate layer comprises a second polymer layer, such as a polydimethylsiloxane (PDMS) layer.

As noted above, the shape of the internal structures (and the corresponding profiles of the passages or channels) is progressively varied (e.g., in a plurality of step-wise increments, and/or in a continuous or “smoothed” fashion) across the length and width of the window to reduce reflections and/or refractions within the window when said enlarged image is projected therethrough. For example, a channel (C) of FIG. 4, while potentially satisfactory in central regions of a window, may be unsatisfactory in more peripheral regions. In this case the shape of the walls, or the profile of the channel, can be modified in these regions to reduce reflection and/or refractions, as shown in FIG. 5A, or (with still further reduction in reflections and/or refractions) in FIG. 5B.

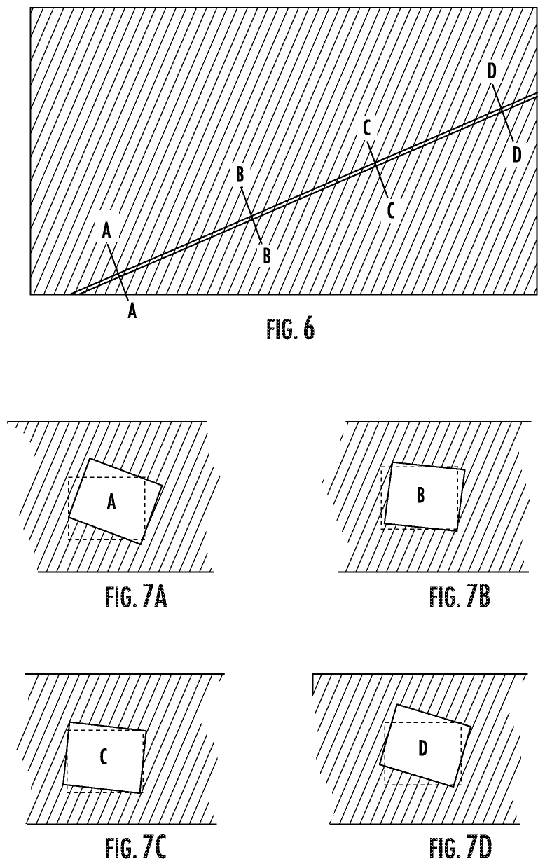

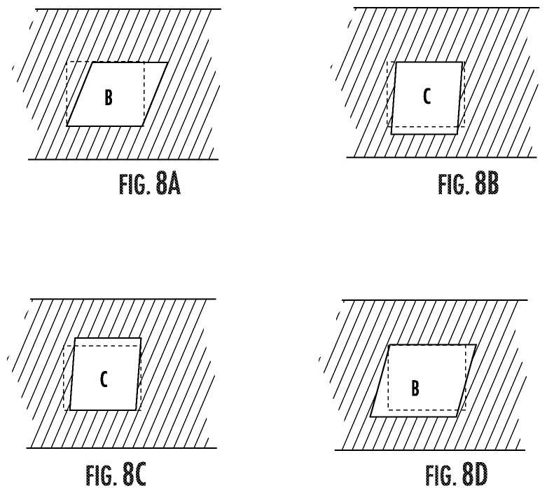

FIG. 6 shows an individual channel, and FIGS. 7A-7D show how the shape of the internal structures, and the corresponding channel profile, are modified along the length of that channel from a prior art configuration (represented by the dashed rectangle), to reduce reflective and/or refractive “ghosting” of the light from that channel. Additional channels in the window (not shown for clarity) can be modified in like manner. Numerous possible alterations of the shape of the structures will be readily apparent to those skilled in the art based on information such as the known refractive indices of, and critical angles for, the material from which the structures are formed, Snell's law, the geometry of the particular apparatus, etc., with an additional example of progressive internal structure variations for the channel of FIG. 6 being given in FIGS. 8A-8D.

In use, the cassettes and apparatus described herein provide a method of making an object (31) from a light polymerizable resin (21) and a data file (e.g., a CAD file, an .stl file, etc.), by (a) filling a resin cassette in an apparatus as described herein with a resin such as described above, and then (b) producing the object from said data file and said resin by intermittently and/or continuously exposing said resin to an enlarged image (e.g., that is spatially and temporally modulated) from said light source to photopolymerize said resin, while advancing said carrier platform and said resin cassette away from one another.

The foregoing is illustrative of the present invention, and is not to be construed as limiting thereof. The invention is defined by the following claims, with equivalents of the claims to be included therein.

We claim:

1. A resin cassette for an additive manufacturing apparatus, the apparatus having a light engine and a cassette mount operatively associated therewith, the light engine configured for projecting an enlarged projected image through said resin cassette when positioned on said cassette mount, said resin cassette comprising:
(a) a light transmissive window configured to pass the enlarged image therethrough, the window having internal structures defining fluid flow passages therein, with the internal structures distributed across the length and width of said window, and with the internal structures creating reflective and refractive surfaces within said window; and
(b) a circumferential frame connected to and surrounding said window, said window and frame together forming a well configured to receive a light polymerizable resin;
wherein the shape of said internal structures is progressively varied across the length and width of said window to reduce reflections and/or refractions within said window when said enlarged image is projected therethrough.

2. The resin cassette of claim 1, wherein said internal structures comprise walls and said passages comprise laterally aligned channels.

3. The resin cassette of claim 1, wherein said internal structures comprise pillars and said passages comprise intersecting channels.

4. The resin cassette of claim 3, wherein said channels are triangular and/or quadrangular in profile.

5. The resin cassette of claim 1, wherein said window comprises a sandwich of at least top portion an intermediate portion, and a bottom portion, and said internal structures are formed in said intermediate portion.

6. The resin cassette of claim 5, wherein said window bottom portion comprises glass, sapphire, quartz, or transparent aluminum (ALON).

7. The resin cassette of claim 5, wherein said top portion comprises a polymer with a fluorophore dispersed therein.

8. The resin cassette of claim 5, wherein said intermediate layer comprises a second polymer layer comprising a polydimethylsiloxane (PDMS) layer.

9. A bottom-up additive manufacturing apparatus, comprising:
(a) a frame;
(b) a resin cassette associated with said frame, said resin cassette comprising:
(i) a light transmissive window configured to pass the enlarged image therethrough, the window having internal structures defining fluid flow passages therein, with the internal structures distributed across the length and width of said window, and with the internal structures creating reflective and refractive surfaces within said window; and
(ii) a circumferential frame connected to and surrounding said window, said window and frame together forming a well configured to receive a light polymerizable resin;
wherein the shape of said internal structures is progressively varied across the length and width of said window to reduce reflections and/or refractions within said window when said enlarged image is projected therethrough;
(c) a light source positioned below said resin cassette and positioned for projecting an enlarged image through said window;
(d) a removable carrier platform or a carrier platform engagement assembly positioned above said window and operatively associated with said frame; and
(e) a drive operatively associated with said carrier and said frame and configured for advancing said carrier platform and said resin cassette away from one another.

10. The apparatus of claim, wherein said light source comprises a micromirror array or liquid crystal display (LCD) panel.

11. The apparatus of claim 9, wherein said internal structures define fluid flow passages therein, the apparatus further comprising an inhibitor supply operatively associated with said fluid flow passages.

12. The apparatus of claim 11, wherein the inhibitor supply comprises an oxygen concentrator.

13. The apparatus of claim 9, further comprising a controller operatively associated with said light source and said drive.

14. A method of making an object from a light polymerizable resin and a data file, comprising:
(a) filling a resin cassette with said resin, said resin cassette comprising:
(i) a light transmissive window configured to pass the enlarged image therethrough, the window having internal structures defining fluid flow passages therein, with the internal structures distributed across the length and width of said window, and with the internal structures creating reflective and refractive surfaces within said window; and
(ii) a circumferential frame connected to and surrounding said window, said window and frame together forming a well configured to receive a light polymerizable resin;
wherein the shape of said internal structures is progressively varied across the length and width of said window to reduce reflections and/or refractions within said window when said enlarged image is projected therethrough; and
(b) producing said object from said data file and said resin by intermittently and/or continuously exposing said resin to an enlarged image from said light source to photopolymerize said resin, while advancing said carrier platform and said resin cassette away from one another.

15. The method of claim 14, wherein said enlarged image is spatially and temporally modulated.

16. The method of claim 14, wherein said resin comprises a dual cure resin.
